(19) United States
(12) Patent Application Publication
(10) Pub. No.: US 2023/0420704 A1
(43) Pub. Date: Dec. 28, 2023

(54) Thermal Management System for Fuel Cell Vehicles

(71) Applicants: Hyundai Motor Company, Seoul (KR); Kia Corporation, Seoul (KR)

(72) Inventor: Jong Won Kim, Cheonan-si (KR)

(21) Appl. No.: 18/068,612

(22) Filed: Dec. 20, 2022

(30) Foreign Application Priority Data
Jun. 23, 2022 (KR) 10-2022-0076537

(51) Int. Cl. H01M 8/04014; B60H 1/32; H01M 8/04303; H01M 8/04828; H01M 8/04746

(52) U.S. Cl. CPC H01M 8/04014; B60H 1/32281; H01M 8/04303; H01M 8/04843; H01M 8/04761; H01M 2250/20

(57) ABSTRACT

An embodiment thermal management system for a fuel cell vehicle includes a fuel cell that generates product water as a by-product of an electrochemical reaction of fuel and air when electricity is produced by the fuel cell, a refrigerant line through which a refrigerant for an air-conditioning system can be circulated and on which a compressor configured to compress the refrigerant is to be provided, and a heat exchange chamber provided on the refrigerant line so as to enable heat exchange between the product water and the refrigerant.

### CROSS-REFERENCE TO RELATED APPLICATIONS

This application claims the benefit of Korean Patent Application No. 10-2022-0076537, filed on Jun. 23, 2022, which application is hereby incorporated herein by reference.

### TECHNICAL FIELD

The present disclosure relates generally to a thermal management system for fuel cell vehicles.

### BACKGROUND

A fuel cell system is mounted in vehicles that use a fuel cell as a power source. The fuel cell system has a fuel feeder that feeds fuel to fuel cells and an air feeder that feeds air to the fuel cells.

The fuel cell produces electricity using fuel and the air fed thereto. When the fuel cell is driven, the fuel reacts with oxygen in the air, so that electricity is produced and simultaneously product water is generated as a reaction by-product.

Product water, corresponding to several times a fuel quantity used for electricity production when the fuel cell is driven, is incidentally generated. This product water is not recycled and is discharged to the outside, and so thermal energy of the product water is wasted without being utilized.

Meanwhile, even in the case of a heating, ventilation, and air-conditioning system (or an air-conditioning system) that adjusts the interior temperature, humidity, etc. of the vehicle, condensation heat of the refrigerant, generated from the condenser, is discharged to the outside, and wasted without being recycled.

The foregoing is intended merely to aid in the understanding of the background of the present disclosure, and is not intended to mean that the present disclosure falls within the purview of the related art that is already known to those skilled in the art.

### SUMMARY

The present disclosure relates generally to a thermal management system for fuel cell vehicles. Particular embodiments relate to a thermal management system for fuel cell vehicles, the thermal management system being able to make practical use of thermal energy of product water produced and discharged from fuel cells.

Accordingly, embodiments of the present disclosure keep in mind problems occurring in the related art, and embodiments of the present disclosure provide a thermal management system for fuel cell vehicles, the thermal management system being able to recycle fuel cell product water which would otherwise be wasted without being recycled at the fuel cell vehicles so as to improve the commercial value of fuel cell vehicles.

Embodiments of the present disclosure are not limited to the aforementioned description, and other embodiments not explicitly disclosed herein will be clearly understood by a person having ordinary skill in the art from the description provided hereinafter.

According to one embodiment of the present disclosure, there is provided a thermal management system for fuel cell vehicles. The thermal management system may include a fuel cell from which product water is generated as a by-product of an electrochemical reaction of fuel and air when electricity is produced by the electrochemical reaction, a refrigerant line through which a refrigerant for an air-conditioning system (or a heating, ventilation, and air-conditioning system) is circulated and on which a compressor for compressing the refrigerant is provided, and a heat exchange chamber provided on the refrigerant line so as to enable heat exchange between the product water and the refrigerant.

According to an embodiment, the heat exchange chamber may be connected to the air-conditioning system through a first valve member so as to enable the product water to flow.

The heat exchange chamber may accumulate the product water flowing in from the fuel cell while the first valve member is being controlled in a shut-off mode.

The product water accumulated in the heat exchange chamber may be evaporated through heat exchange with the refrigerant and may be supplied to the air-conditioning system through the first valve member when the first valve member is controlled in an open mode.

The refrigerant line may be provided with a condenser disposed downstream of the heat exchange chamber. The refrigerant evaporating the product water in the heat exchange chamber may be super-cooled in the condenser.

The fuel cell may be connected to the heat exchange chamber and the vehicle outer portion through the second valve member so that the product water is enabled to flow.

According to another embodiment, the heat exchange chamber may be connected to the electricity generating turbine through a third valve member so that the product water is enabled to flow.

The heat exchange chamber may be accumulated with the product water flowing in from the fuel cell while the third valve member is being controlled in the shut-off mode.

The product water accumulated in the heat exchange chamber may be evaporated through the heat exchange with the refrigerant and may be supplied to the turbine to rotate the turbine when the third valve member is controlled in the open mode.

The turbine may be electrically connected to an in-vehicle battery. Electricity produced by the turbine may be stored in the battery.

An ejector, which sends the product water discharged from the fuel cell to the heat exchange chamber under a pressure, may be provided between the fuel cell and the heat exchange chamber. The ejector may use the product water, supplied through the third valve member, as a working fluid.

According to another embodiment, the heat exchange chamber may be connected to the air compressor for the fuel cell through a fifth valve member so that the product water is enabled to flow.

The air compressor may include a first impeller configured to be rotated by the production water supplied through the fifth valve member, a second impeller integrally connected to the first impeller through a rotation shaft and configured to compress air supplied to the fuel cell, and a shaft driver configured to rotate the rotation shaft when an electric current is applied.

According to the means to be solved of the aforementioned problems, the thermal management system for fuel cell vehicles according to embodiments of the present disclosure has the effects as follows.

First, it is possible to increase cooling capacity by recycling product water produced and discharged from the fuel cell and by condensing and cooling refrigerant for the air-conditioning system.

Second, it is possible to reduce consumption power and load for vehicle interior heating of the air-conditioning system to increase heating efficiency by recycling the product water of the fuel cell to additionally heat the refrigerant for the air-conditioning system.

Third, odor generated during the use of the air-conditioning system is removed by recycling the product water of the fuel cell to sterilize the evaporator and ducts of the air-conditioning system, thereby comfort of the vehicle interior space is secured and consequently the commercial value of the vehicle is improved.

Fourth, the energy efficiency of the fuel cell system is increased by recycling the product water of the fuel cell to charge the in-vehicle battery.

Fifth, the energy efficiency of the fuel cell system is increased by recycling the product water of the fuel cell to drive the air compressor for the fuel cell.

The embodiments of the present disclosure are not limited to the above-mentioned embodiments, and other unmentioned embodiments of the present disclosure will be clearly understood to those having the common knowledge in the technical field to which the present disclosure belongs.

### BRIEF DESCRIPTION OF THE DRAWINGS

The above and other objectives, features, and other advantages of embodiments of the present disclosure will be more clearly understood from the following detailed description when taken in conjunction with the accompanying drawings, in which:

FIG. 1 is a figure illustrating a thermal management system for fuel cell vehicles according to a first embodiment of the present disclosure;

FIG. 2 is a figure illustrating an operating state during a sterilizing mode of the thermal management system according to the first embodiment of the present disclosure;

FIG. 3 is a figure illustrating an operating state during a refrigerant super-cooling mode of the thermal management system according to the first embodiment of the present disclosure;

FIG. 4 is a figure illustrating a thermal management system for fuel cell vehicles according to a second embodiment of the present disclosure;

FIG. 5 is a figure illustrating an operating state during a battery charging mode of the thermal management system according to the second embodiment of the present disclosure;

FIG. 6 is a figure illustrating an operating state during a refrigerant super-cooling mode of the thermal management system according to the second embodiment of the present disclosure;

FIG. 7 is a figure illustrating an operating state during a heating mode of the thermal management system according to the second embodiment of the present disclosure;

FIG. 8 is a figure illustrating an operating state during a general heating mode of the thermal management system according to the second embodiment of the present disclosure;

FIG. 9 is a figure illustrating an operating state during a sterilizing mode of a thermal management system for fuel cell vehicles according to a third embodiment of the present disclosure;

FIG. 10 is a figure illustrating a thermal management system for fuel cell vehicles according to a fourth embodiment of the present disclosure;

FIG. 11 is a figure illustrating an operating state of the thermal management system according to the fourth embodiment of the present disclosure; and

FIG. 12 is a figure illustrating an internal structure of an air compressor applied to the thermal management system according to the fourth embodiment of the present disclosure.

### DETAILED DESCRIPTION OF ILLUSTRATIVE EMBODIMENTS

Specific structural and functional descriptions of embodiments of the present disclosure disclosed herein are only for illustrative purposes of the embodiments of the present disclosure. The present disclosure may be embodied in many different forms without departing from the spirit and significant characteristics of the present disclosure.

In addition, throughout the specification, when a certain portion “includes” a certain component, this indicates that the other components are not excluded, and may be further included unless otherwise noted.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Hereinafter, embodiments of the present disclosure will be described with reference to the accompanying drawings. Illustrations in the accompanying drawings are provided to assist in the understanding of embodiments of the present disclosure and may differ from actually-implemented forms.

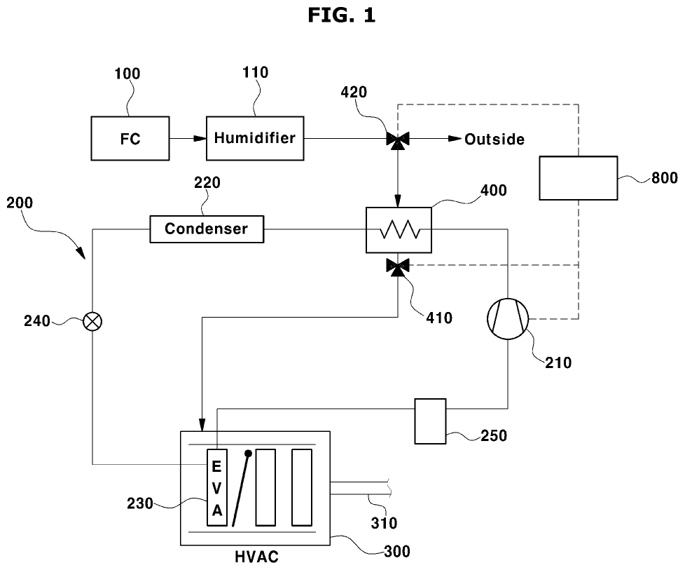

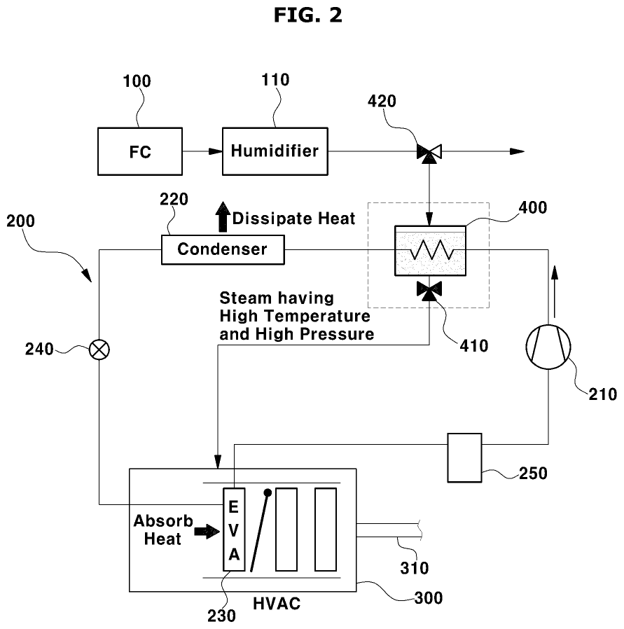

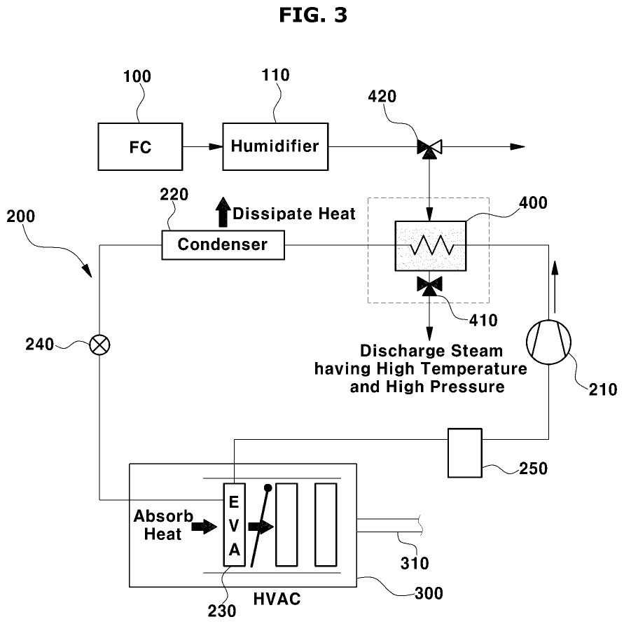

FIG. 1 is a figure illustrating a thermal management system for fuel cell vehicles according to a first embodiment of the present disclosure, FIG. 2 is a figure illustrating an operating state during a sterilizing mode of the thermal management system according to the first embodiment of the present disclosure, and FIG. 3 is a figure illustrating an operating state during a refrigerant super-cooling mode of the thermal management system according to the first embodiment of the present disclosure.

As illustrated in FIG. 1, the thermal management system for fuel cell vehicles according to a first embodiment of the present disclosure may be configured to include a fuel cell wo, a refrigerant line 200, and a heat exchange chamber 400.

The fuel cell wo is a power generating apparatus that is supplied with a fuel and air and generates electricity. The fuel cell wo is supplied with the fuel from a fuel feeder inside a vehicle, and is fed with the air from an air feeder inside the vehicle. The air feeder is configured to include an air compressor that compresses the air fed to the fuel cell 100.

Here, the fuel cell 100 may refer to a fuel cell stack that is made up of a plurality of fuel cells.

The fuel cell 100 generates electricity by means of an electrochemical reaction of the fuel and the oxygen in the air. In this case, hydrogen may be used as the fuel. When the fuel cell 100 is driven, the electricity is generated by the electrochemical reaction of the fuel and the oxygen, and simultaneously water is generated as a reaction by-product of the electrochemical reaction. In this case, the water generated from the fuel cell 100 is referred to as “product water” or “fuel cell product water.”

The refrigerant line 200 is a refrigerant circuit through which the refrigerant for an air-conditioning system is circulated. As known, the air-conditioning system may cool or heat air, which is fanned into the vehicle interior space, using the refrigerant.

The refrigerant line 200 is equipped with a compressor 210, a condenser 220, an evaporator (EVA) 230, an expansion valve 240, a vapor-liquid separator 250, and so on. The refrigerant line 200 may have the compressor 210, the condenser 220, the expansion valve 240, the evaporator 230, and the vapor-liquid separator 250 disposed in that order on the basis of a refrigerant flow direction. In addition, the heat exchange chamber 400 may be disposed downstream of the evaporator 230 and upstream of the condenser 220.

The compressor 210 functions as an electric motor compressor whose operation is controlled by a control unit 800, which compresses a refrigerant flowing into an interior thereof and discharges the compressed refrigerant in a high-temperature high-pressure state. The compressor 210 compresses and discharges the refrigerant, thereby the refrigerant of the refrigerant line 200 is circulated.

The condenser 220 functions to condensate the refrigerant discharged from the compressor 210, liquefies a gas-phase refrigerant in a high-temperature high-pressure state, and sends the liquefied refrigerant toward the expansion valve 240.

The expansion valve 240 is disposed between the condenser 220 and the evaporator 230, reduces the pressure of the liquid-phase refrigerant flowing through the condenser 220 in a low-temperature low-pressure state, and then may send the liquid-phase refrigerant whose pressure has been reduced to the evaporator 230. The operation of the expansion valve 240 is controlled by the control unit 800.

The evaporator 230 is provided to enable the refrigerant to flow in the housing of a heating, ventilation, and air-conditioning (HVAC) system 300, and cools air through heat exchange using the refrigerant when the HVAC system 300 is driven in a cooling mode. In this case, the liquid-phase refrigerant passing through the evaporator 230 absorbs thermal energy of the air while undergoing phase transition into a gas phase. The air cooled by the evaporator 230 is fed to the vehicle interior space through a discharge duct 310 of the HVAC system 300.

The vapor-liquid separator 250 is configured to separate the refrigerant discharged from the evaporator 230 in a low-temperature low-pressure state into a gas-phase refrigerant and a liquid-phase refrigerant. The vapor-liquid separator 250 sends only the vapor-phase refrigerant among the refrigerants passing through the evaporator 230.

The heat exchange chamber 400 is provided for the refrigerant line 200 so as to make it possible to perform heat exchange between the product water discharged from the fuel cell 100 and the refrigerant circulating along the refrigerant line 200.

The heat exchange chamber 400 may be configured as a hollow chamber that is formed to surround a partial section of the refrigerant line 200. As can be seen from FIG. 1, the heat exchange chamber 400 may be formed to hermetically enclose the refrigerant line section between the condenser 220 and the compressor 210.

In other words, the heat exchange chamber 400 is penetrated by the refrigerant line 200, and the refrigerant circulating along the refrigerant line 200 flows through an interior of the heat exchange chamber 400. The product water flowing into the inner space of the heat exchange chamber 400 performs heat exchange with the refrigerant flowing into the refrigerant line 200 from the outside of the refrigerant line 200.

The heat exchange chamber 400 is connected to the HVAC system 300 through a first valve member 410 so as to enable a fluid flow, and is connected to the fuel cell 100 through the second valve member 420 so as to enable a fluid flow. The heat exchange chamber 400 may release the product water to at least any one of the HVAC system 300 and the atmosphere through the first valve member 410, and may be supplied with the liquid-phase product water discharged from the fuel cell 100 through the second valve member 420.

The product water subjected to the heat exchange with the refrigerant in the heat exchange chamber 400 flows to the HVAC system 300 through the first valve member 410. That is, the HVAC system 300 is supplied with the product water that is discharged after performing the heat exchange with the refrigerant in the heat exchange chamber 400. The HVAC system is an apparatus that is mounted in the vehicle equipped with the fuel cell 100 and the refrigerant line 200 so as to adjust a temperature, humidity, etc. of the vehicle interior space.

The product water, discharged to the HVAC system 300 through the first valve member 410, may be fed to the evaporator 230 provided to the refrigerant line 200 of the HVAC system 300. The refrigerant circulating along the refrigerant line 200 may perform heat exchange with air discharged into the vehicle interior space when passing through the evaporator 230 disposed in the inner portion of the HVAC system 300.

The product water flowing into the heat exchange chamber 400 may be accumulated in the heat exchange chamber 400 without being discharged from the heat exchange chamber 400 while the HVAC system 300 is operated in the cooling mode. While the HVAC system 300 is operated in the cooling mode, the refrigerant of the refrigerant line 200 heats the product water in the heat exchange chamber 400, and then is emitted from the heat exchange chamber 400.

Referring to FIG. 2, the refrigerant passing through the heat exchange chamber 400 may be condensed and liquefied at the condenser 220 disposed downstream of the heat exchange chamber 400 while dissipating heat, and may be decompressed and cooled by the expansion valve 240. The refrigerant cooled in this manner absorbs thermal energy of the air at the evaporator 230 disposed upstream of the compressor 210 when the HVAC system 300 is operated in the cooling mode, and cools the air sent to the vehicle interior space.

Meanwhile, the refrigerant discharged from the compressor 210 of the refrigerant line 200 passes through the heat exchange chamber 400 in a state in which the temperature and the pressure thereof are raised at the compressor 210. Thus, the product water accumulated in the heat exchange chamber 400 performs heat exchange with the refrigerant under relatively high temperature and pressure.

The product water is delivered with the thermal energy of the refrigerant in the heat exchange chamber 400 and is converted into a gas state. The product water is changed into steam having a high temperature and pressure state in the heat exchange chamber 400 and is stored for a fixed time. For example, the steam (i.e., the product water in the gas state) in the heat exchange chamber 400 may be stored in the heat exchange chamber 400 until the vehicle comes to a stop.

To control the release and the flow of the product water stored in the heat exchange chamber 400, an operation of the first valve member 410 may be controlled.

The first valve member 410 is configured to be able to open/close a product water discharge port of the heat exchange chamber 400 and is configured to be able to discharge the product water in the heat exchange chamber 400 to at least any one of the HVAC system 300 and the outdoor portion of the vehicle. For example, the first valve member 410 may be a three-way valve that is configured to discharge the product water, stored in the heat exchange chamber 400, to the outdoor portion of the vehicle, or to supply the stored product water to the HVAC system 300. The operation of the first valve member 410 may be controlled by the control unit 800.

The control unit 800 may be a controller that is previously provided inside the vehicle. For example, the control unit 800 may be a fuel cell controller that performs overall control of the fuel cell system or an air-conditioning controller that performs overall control of the HVAC system.

The control unit 800 operates the first valve member 410 in a close mode, and thereby may prevent the product water flowing into the heat exchange chamber 400 from being discharged from the heat exchange chamber 400. That is, the heat exchange chamber 400 accumulates the product water introduced from the fuel cell 100 while the first valve member 410 is controlled in the close mode.

Product water (i.e., steam having a high-temperature and high-pressure state) evaporated in the heat exchange chamber 400 through heat exchange with the refrigerant is supplied to the evaporator 230 of the HVAC system 300 (see FIG. 2) or is discharged to the outdoor portion of the vehicle (see FIG. 3) when the first valve member 410 is operated in an open mode by the control unit 800.

The control unit 800 may operate the first valve member 410 in a first open mode as needed. For example, the first valve member 410 may be operated and controlled in the first open mode when the vehicle is stopped after the HVAC system 300 is operated in the cooling mode during driving of the vehicle. That is, the first valve member 410 may be controlled in the first open mode when the vehicle is stopped and the operation of the HVAC system 300 is terminated.

When operated in the first open mode, the first valve member 410 opens an internal fluid channel so as to allow the product water inside the heat exchange chamber 400 to be supplied to the HVAC system 300.

Gas-phase product water supplied to the HVAC system 300 through the first valve member 410 may sterilize the evaporator 230 and the discharge duct 310 of the HVAC system 300. The gas-phase product water supplied to the HVAC system 300 passes through the evaporator 230 and the discharge duct 310, and then may be discharged into the vehicle interior space.

In this manner, when the evaporator 230 and the discharge duct 310 of the HVAC system 300 are sterilized, odor generated when the HVAC system 300 is used is removed, and comfort of the vehicle interior space is secured, so that a commercial value of the vehicle is improved.

Meanwhile, the second valve member 420 may be a three-way valve that is configured to allow the product water discharged from the fuel cell 100 to be released to the vehicle outdoor portion or to be supplied to the heat exchange chamber 400. The second valve member 420 controls a flow of the product water discharged from the fuel cell 100, and operation thereof may be controlled by the control unit 800.

Further, the second valve member 420 may conduct a function of a pressure regulator. For example, the second valve member 420 releases a part of the product water discharged from the fuel cell 100 to the vehicle outdoor portion, and thereby may adjust a pressure of the product water supplied to the heat exchange chamber 400.

In addition, a humidifier no may be disposed between the fuel cell 100 and the second valve member 420. The humidifier no acts to humidify the air supplied to the fuel cell 100. The humidifier no may utilize the product water to humidify the air supplied to the fuel cell 100.

Further, the thermal management system may also be actuated in a refrigerant super-cooling mode of super-cooling the refrigerant of the refrigerant line 200 when the first valve member 410 is operated in a second open mode.

When the first valve member 410 is operated in the second open mode, the product water evaporated in the heat exchange chamber 400 through heat exchange with the refrigerant is discharged to the vehicle outdoor portion without being supplied to the evaporator 230 of the HVAC system 300 as shown in FIG. 3.

The refrigerant, compressed by the compressor 210 of the refrigerant line 200 and discharged in a high-temperature and high-pressure state, passes through the inner portion of the heat exchange chamber 400 in which the product water is accumulated while the HVAC system 300 is actuated in the cooling mode, and thereby conducting heat exchange with the product water in a liquid state. In this case, the product water in the liquid state absorbs the thermal energy of the refrigerant as a sensible heat and a latent heat, thereby reducing a condensation load of the condenser 220.

The refrigerant evaporating the product water in the heat exchange chamber 400 flows into the condenser 220 disposed downstream of the heat exchange chamber 400 and is condensed and cooled at the condenser 220 through heat exchange with the ambient air. The refrigerant is first cooled in the heat exchange chamber 400 disposed upstream of the condenser 220, thereby an effect of being subcooled at the condenser 220 is generated. As the refrigerant is subcooled at the condenser 220, air-conditioning capacity of the HVAC system 300 is increased.

The product water in a gas state, heated in the heat exchange chamber 400 by the refrigerant, is discharged to the outdoor portion through the first valve member 410.

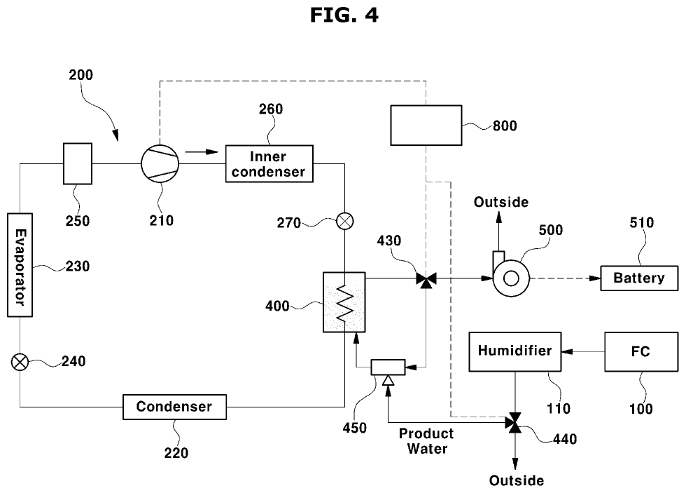

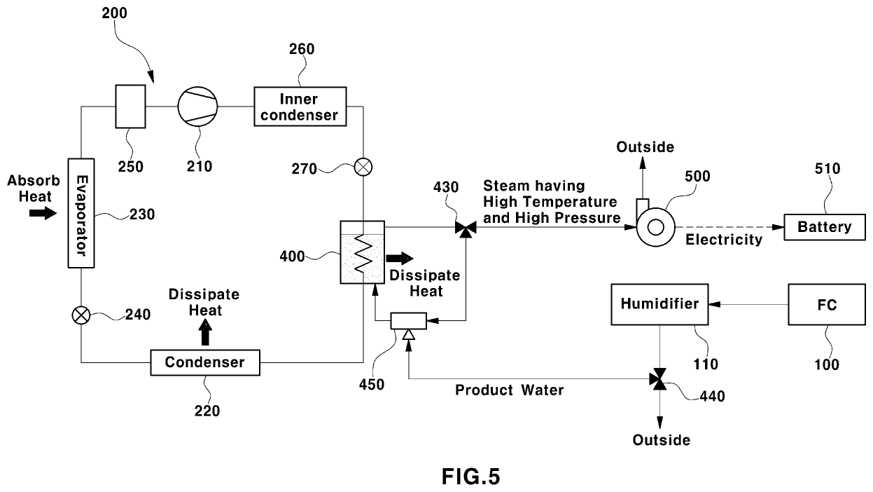

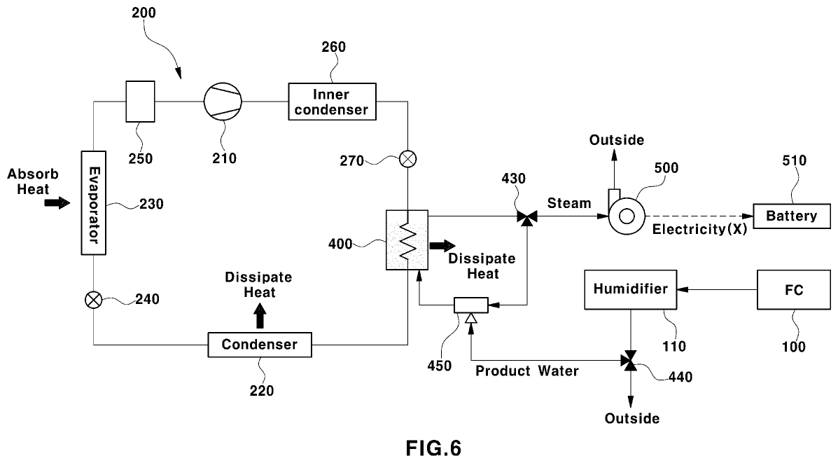

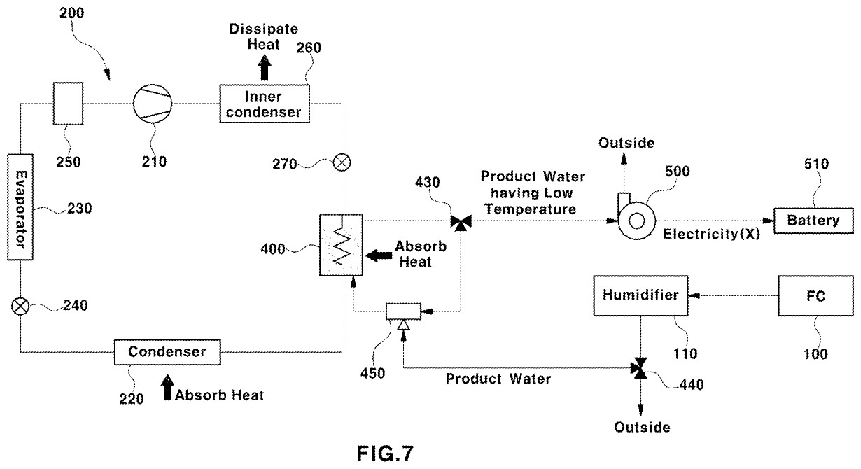

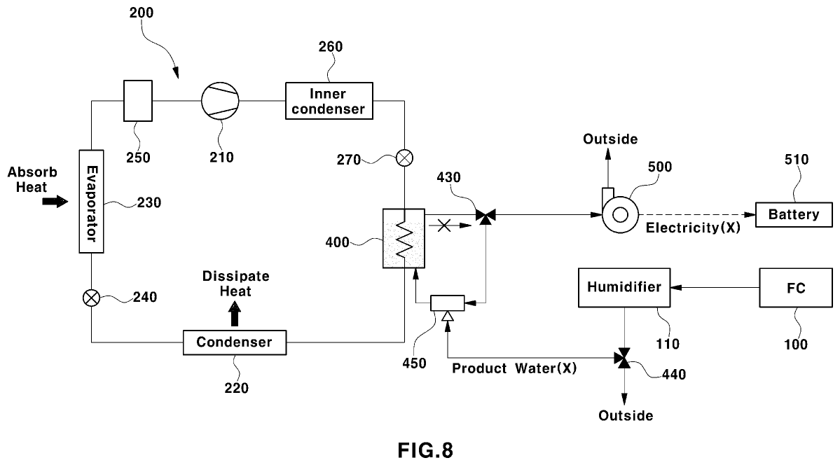

FIG. 4 illustrates a thermal management system for fuel cell vehicles according to a second embodiment of the present disclosure. FIG. 5 illustrates an actuated state of the thermal management system for fuel cell vehicles according to the second embodiment of the present disclosure in a battery charging mode. FIG. 6 illustrates an actuated state of the thermal management system for fuel cell vehicles according to the second embodiment of the present disclosure in a refrigerant super-cooling mode. FIG. 7 illustrates an actuated state of the thermal management system for fuel cell vehicles according to the second embodiment of the present disclosure in a heating mode. FIG. 8 illustrates an actuated state of the thermal management system for fuel cell vehicles according to the second embodiment of the present disclosure in a general cooling mode.

Here, it should be noted that, among the explanation of the thermal management system according to the second embodiment, the same explanation as the configuration duplicated with the thermal management system of the first embodiment may be omitted.

As illustrated in FIG. 4, the thermal management system for fuel cell vehicles according to embodiments of the present disclosure may be configured to include a fuel cell 100, a refrigerant line 200, a heat exchange chamber 400, and an electricity generating turbine 500.

In other words, the thermal management system may be configured to further include an internal condenser 260 disposed at the refrigerant line 200 and the electricity generating turbine 500 connected to the heat exchange chamber 400.

Referring to FIG. 4, the refrigerant line 200 is provided with the internal condenser 260 and a second expansion valve 270 in addition to the compressor 210, the condenser 220, the evaporator 230, the first expansion valve 240, and the vapor-liquid separator 250.

The refrigerant line 200 may be disposed in the order of the compressor 210, the internal condenser 260, the second expansion valve 270, the condenser 220, the first expansion valve 240, the evaporator 230, and the vapor-liquid separator 250 on the basis of a refrigerant flowing direction. In this case, the heat exchange chamber 400 may be disposed between the condenser 220 and the second expansion valve 270. The heat exchange chamber 400 may be disposed downstream of the compressor 210 and upstream of the condenser 220.

The internal condenser 260 is disposed inside a housing of the HVAC system 300 to selectively condense the refrigerant discharged from the compressor 210. Air fanned to the vehicle interior portion through the HVAC system 300 selectively passes through the internal condenser 260. The internal condenser 260 condenses and liquefies the refrigerant through heat exchange with the air. For example, when the HVAC system 300 is actuated in the cooling mode, the internal condenser 260 does not condense the refrigerant.

The first expansion valve 240 is disposed between the condenser 220 and the evaporator 230, decompresses and cools the liquid phase refrigerant, which passes through the condenser 220, in a low-temperature and low-pressure state, and then may send the liquid phase refrigerant to the evaporator 230. The second expansion valve 270 is disposed between the internal condenser 260 and the heat exchange chamber 400, decompresses and cools the refrigerant discharged from the compressor 210, and then may release the cooled refrigerant to the heat exchange chamber 400. An operation of the first expansion valve 240 and an operation of the second expansion valve 270 are controlled by the control unit 800.

The heat exchange chamber 400 is disposed on a refrigerant line section between the compressor 210 and the condenser 220 and is configured to enable heat exchange between the product water and the refrigerant. To be specific, the heat exchange chamber 400 is disposed on a refrigerant line section between the second expansion valve 270 and the condenser 220 which are disposed downstream of the compressor 210.

The heat exchange chamber 400 may be formed as a hollow chamber having a given volume on a refrigerant line section between the compressor 210 and the condenser 220. The product water flowing into an internal space of the heat exchange chamber 400 conducts heat exchange with the refrigerant discharged from the compressor 210.

The heat exchange chamber 400 is connected to the electricity generating turbine 500 through a third valve member 430 so as to make the product water flow possible and is connected to the fuel cell 100 through a fourth valve member 440 so as to make the product water flow possible.

The product water discharged from the fuel cell 100 through the fourth valve member 440 flows into the heat exchange chamber 400, and the product water subjected to the heat exchange with the refrigerant in the heat exchange chamber 400 flows to the turbine 500 through the third valve member 430.

An ejector 450, which sends the product water discharged from the fuel cell wo to the heat exchange chamber 400 under pressure, is provided between the fuel cell 100 and the heat exchange chamber 400. To be more specific, the ejector 450 may be disposed between the fourth valve member 440 and the heat exchange chamber 400.

Further, the ejector 450 is connected to the heat exchange chamber 400 through the third valve member 430, and is supplied with the product water discharged from the heat exchange chamber 400 through the third valve member 430. The ejector 450 is configured to use the product water supplied through the third valve member 430 as a working fluid.

That is, the ejector 450 may be configured to suction the product water discharged from the fuel cell wo using the product water discharged from the heat exchange chamber 400. In other words, the ejector 450 suctions the product water using a spraying force (i.e., pressure energy) of the product water supplied through the third valve member 430 and sends the suctioned product water to the heat exchange chamber 400 under a pressure.

The third valve member 430 may be configured as a three-way valve connected to the heat exchange chamber 400 and the turbine 500 so as to enable the product water to flow to the ejector 450. The third valve member 430 may supply a part of the product water, discharged from the heat exchange chamber 400, to the ejector 450.

Further, the fourth valve member 440 may be configured as a three-way valve connected to the fuel cell 100, the ejector 450, and the outer portion of the vehicle so as to enable the product water to flow. The fourth valve member 440 discharges a part of the product water, discharged from the fuel cell 100, into the air, and thereby may adjust a pressure of the product water supplied to the ejector 450. The humidifier no may be disposed between the fourth valve member 440 and the fuel cell 100.

The turbine 500 acts as a rotary mechanical apparatus and is rotated by the product water (i.e., the high-pressure steam) discharged from the heat exchange chamber 400 in a high-temperature and high-pressure gas state.

The turbine 500 is configured to be rotated by the gas-phase product water supplied through the third valve member 430, and is electrically connected to a battery 510. The turbine 500 may supply electric energy generated by rotation thereof to the battery 510, and may store the supplied electric energy in the battery 510.

Although not illustrated in the figure, an energy converting apparatus, which converts a rotation force of the turbine 500 into electric energy and charges the converted electric energy to the battery 510, may be provided between the turbine 500 and the battery 510. The energy converting apparatus belongs to the well-known technology, and thus detailed description thereof will be omitted.

The turbine 500 produces electric energy charged to the battery 510 while being rotated by the high-pressure steam. The high-pressure steam rotates the turbine 500 and then is discharged to the vehicle external portion. The battery 510 may be an in-vehicle battery that is supplied and charged with the electric energy produced from the fuel cell 100.

AS illustrated in FIGS. 5 to 8, the thermal management system configured as in the second embodiment may be actuated in a battery charging mode, a refrigerant super-cooling mode, a heating mode, and a general cooling mode.

As illustrated in FIG. 5, when the thermal management system is driven in the battery charging mode, the liquid-state product water generated from the fuel cell 100 is supplied to the heat exchange chamber 400 through the fourth valve member 440 and the ejector 450. The product water flowing into the inner portion of the heat exchange chamber 400 is accumulated in the heat exchange chamber 400 while the third valve member 430 is operated in a partial shut-off mode (i.e., a first shut-off mode).

When the third valve member 430 is operated in the first shut-off mode, the third valve member 430 shuts off a fluid channel between the heat exchange chamber 400 and the turbine 500 and blocks the product water in the heat exchange chamber 400 from being supplied to the turbine 500. Further, when operated in the first shut-off mode, the third valve member 430 may open the fluid channel between the heat exchange chamber 400 and the ejector 450.

The high-pressure and high-temperature refrigerant, discharged from the compressor 210 of the refrigerant line 200, conducts heat exchange with the product water accumulated in the heat exchange chamber 400 while passing through the inner portion of the heat exchange chamber 400. In this case, the product water in the heat exchange chamber 400 is delivered with the thermal energy of the refrigerant and undergoes phase transition into a steam having a high-pressure state.

The steam having the high-pressure state is supplied to the turbine 500 through the third valve member 430 and rotates the turbine 500. Electric energy produced by a rotating force of the turbine 500 is stored in the battery 510, and accordingly energy efficiency of the fuel cell system is increased.

In this case, the third valve member 430 is operated in a full open mode (i.e., a third open mode). When operated in the third open mode, the third valve member 430 opens both a fluid channel between the heat exchange chamber 400 and the turbine 500 and a fluid channel between the heat exchange chamber 400 and the ejector 450.

As illustrated in FIG. 6, the thermal management system may be operated in the refrigerant super-cooling mode. In this case, like the battery charge mode, the product water in the liquid state which is generated from the fuel cell 100 is supplied to the heat exchange chamber 400 through the fourth valve member 440 and the ejector 450. The product water flowing into the inner portion of the heat exchange chamber 400 is accumulated in the heat exchange chamber 400 while the third valve member 430 is operated in the first shut-off mode.

The high-pressure and high-temperature refrigerant discharged from the compressor 210 of the refrigerant line 200 conducts heat exchange with the product water accumulated in the heat exchange chamber 400 while flowing through the inner portion of the heat exchange chamber 400. In this case, the product water in the heat exchange chamber 400 absorbs the condensation heat of the refrigerant and undergoes phase transition into steam having a high-temperature and high-pressure state.

The refrigerant discharged from the compressor 210 is additionally heat-radiated in the heat exchange chamber 400 through the heat exchange with the product water before heat is radiated from the condenser 220, and thereby increasing cooling capacity of the HVAC system 300 actuated in the cooling mode.

In other words, the refrigerant whose heat is radiated from the heat exchange chamber 400 and the condenser 220 is changed in a super-cooled state and may reduce a cooling load of the HVAC system 300.

In addition, the steam having the high-pressure state, discharged from the heat exchange chamber 400 to the turbine 500 through the third valve member 430, is discharged to the vehicle external portion through the turbine 500. When the thermal management system is operated in the refrigerant super-cooling mode, the electric connection of the turbine 500 with the battery 510 is released by the control unit 800.

Further, as illustrated in FIG. 7, the thermal management system may also be operated in the heating mode. The product water in a liquid state, generated from the fuel cell 100, is supplied to and accumulated in the heat exchange chamber 400 through the fourth valve member 440. In this case, the third valve member 430 is operated so as to shut off the channel between the heat exchange chamber 400 and the ejector 450 to thereby prevent the product water from circulating toward the ejector 450. Therefore, the product water flows through the ejector 450 into the heat exchange chamber 400 but is not sent by the ejector 450 under a pressure. The ejector 450 may be replaced by a pump device.

The product water flowing into the inner portion of the heat exchange chamber 400 is accumulated in the heat exchange chamber 400 while the third valve member 430 is operated in the full shut-off mode. When the third valve member 430 is operated in the full shut-off mode, the product water is not discharged from the heat exchange chamber 400. That is, when the third valve member 430 is operated in the full shut-off mode, the third valve member 43o shuts off both the fluid channel between the heat exchange chamber 400 and the turbine 500 and the fluid channel between the heat exchange chamber 400 and the ejector 450.

When the HVAC system 300 is operated in the heating mode, air sent to the vehicle interior space through the discharge duct 310 absorbs the condensation heat of the refrigerant at the internal condenser 260 and is heated. Accordingly, the high-temperature and high-pressure refrigerant discharged from the compressor 210 is heat-radiated at the internal condenser 260 and flows into the heat exchange chamber 400 in a state in which the refrigerant is reduced in temperature and pressure at the second expansion valve 270.

In this case, the refrigerant flowing into the heat exchange chamber 400 absorbs the thermal energy of the product water and is supplied to the evaporator 230 of the HVAC system 300 from the condenser 220 disposed downstream of the heat exchange chamber 400 in a state in which heat is additionally absorbed by heat exchange with the ambient air.

The refrigerant becomes the high-temperature and high-pressure state through the heat absorbing process at the condenser 220 and the heat exchange chamber 400, and thereby may reduce consumption electric power and load for the heating of the HVAC system 300.

Further, the product water in the heat exchange chamber 400 transmits the thermal energy to the refrigerant, is discharged to the turbine 500 through the third valve member 43o in a low-temperature liquid state, and is discharged to the vehicle outer portion through the turbine 500. When the thermal management system is operated in the heating mode, the turbine 500 undergoes electric disconnection from the battery 510 by the control unit 800.

Further, as illustrated in FIG. 8, the thermal management system may also be operated in the general cooling mode. In this case, the third valve member 430 is operated in the full shut-off mode, and the fourth valve member 440 is operated in the partial shut-off mode.

Accordingly, the product water of the fuel cell 100 is not supplied to the heat exchange chamber 400 and is all discharged to the vehicle outer portion through the fourth valve member 440.

As the HVAC system 300 is operated in the common cooling mode, the refrigerant discharged from the compressor 210 of the refrigerant line 200 absorbs the thermal energy of the air at the evaporator 230. Low-temperature air discharging thermal energy from the evaporator 230 to the refrigerant is sent to the vehicle interior space through the discharge duct 310.

In addition, it is possible to open the fluid channel of the fourth valve member 44o adjacent to the ejector 450 as needed and to discharge the product water accumulated in the heat exchange chamber 400 to the outside.

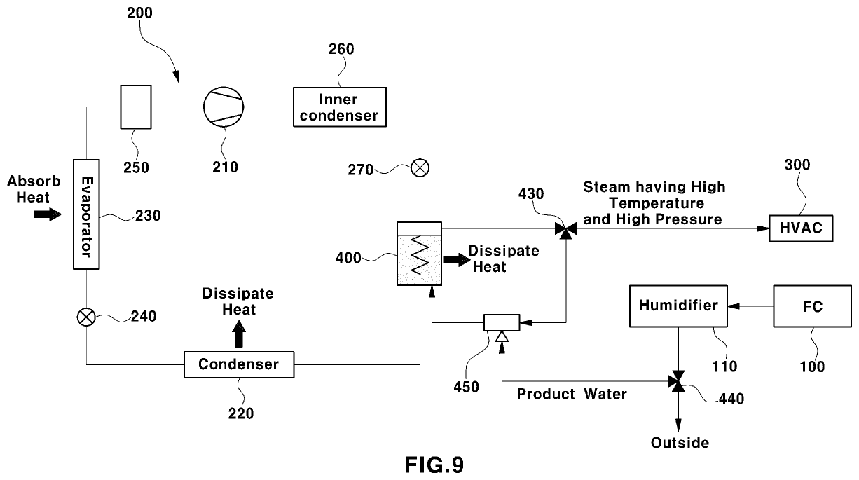

Meanwhile, the thermal management system for fuel cell vehicles according to embodiments of the present disclosure may be configured to include the HVAC system 300 in place of the electricity generating turbine 500 as in a third embodiment illustrated in FIG. 9. That is, the thermal management system may be configured to include the HVAC system 300 in place of the turbine 500 that is connected to the heat exchange chamber 400 through the third valve member 430. In this case, the thermal management system may be operated in the sterilizing mode.

As illustrated in FIG. 9, when the thermal management system is operated in the sterilizing mode, the product water in the liquid state which is generated from the fuel cell 100 is supplied to the heat exchange chamber 400 through the fourth valve member 440 and the ejector 450. The product water flowing into the inner portion of the heat exchange chamber 400 is accumulated in the heat exchange chamber 400 without being discharged to the outer portion of the heat exchange chamber 400. The product water is accumulated in the heat exchange chamber 400 while the third valve member 430 is operated in the partial shut-off mode.

When the third valve member 430 is operated in the partial shut-off mode, the third valve member 430 shuts off the fluid channel between the heat exchange chamber 400 and the HVAC system 300 and interrupts the product water in the heat exchange chamber 400 from being supplied to the HVAC system 300. When the third valve member 430 is operated in the partial shut-off mode, the fluid channel between the heat exchange chamber 400 and the ejector 450 may be opened.

The high-pressure and high-temperature refrigerant discharged from the compressor 210 of the refrigerant line 200 conducts heat exchange with the product water accumulated in the heat exchange chamber 400 while passing through the inner portion of the heat exchange chamber 400. In this case, the product water in the heat exchange chamber 400 is transmitted with thermal energy of the refrigerant and is subjected to phase transition into the steam having a high-pressure state.

The steam may be stored in the heat exchange chamber 400 for a constant time. For example, the steam may be stored in the heat exchange chamber 400 until the vehicle during driving is stopped and the cooling mode of the HVAC system 300 is terminated.

When the third valve member 430 opens the fluid channel between the heat exchange chamber 400 and the HVAC system 300, steam having the high-temperature and high-pressure state (i.e., product water in a gas state) which is discharged from the heat exchange chamber 400 is supplied to the HVAC system 300 and may sterilize the evaporator 230 and the discharge duct 310 of the HVAC system 300.

When the HVAC system 300 is driven in the cooling mode, the condenser 220 of the refrigerant line 200 discharges the condensation heat of the refrigerant while condensing the refrigerant, and the evaporator 230 absorbs thermal energy from the air sent to the vehicle interior space.

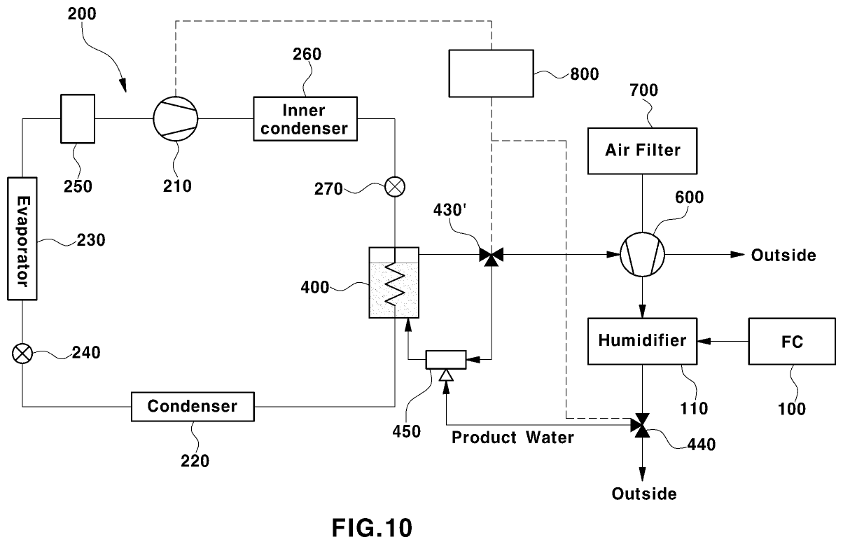

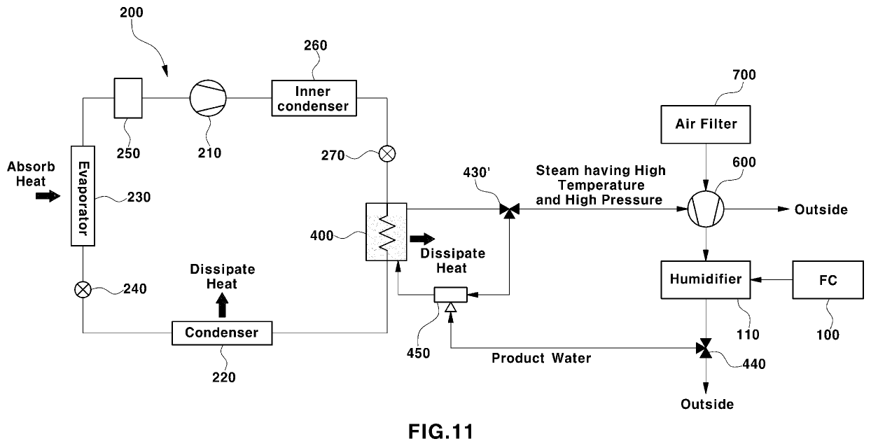

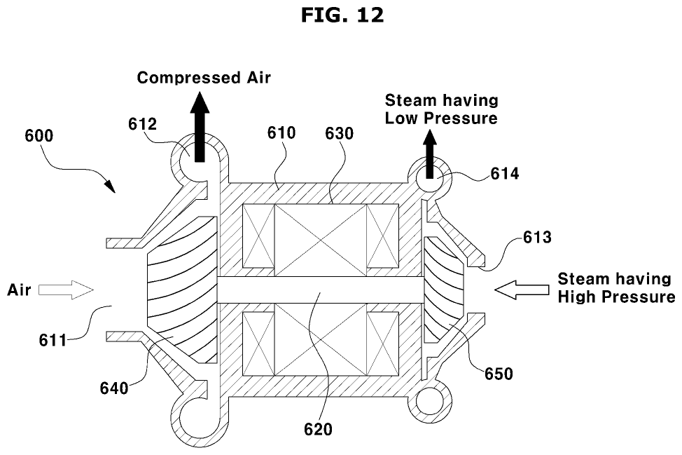

FIG. 10 illustrates a thermal management system for fuel cell vehicles according to a fourth embodiment of the present disclosure. FIG. 11 illustrates an actuated state of the thermal management system according to the fourth embodiment of the present disclosure. FIG. 12 illustrates an internal structure of an air compressor applied to the thermal management system according to the fourth embodiment of the present disclosure.

Here, it is noted that, among the description of the thermal management system according to the fourth embodiment, the same description as the thermal management system of a configuration duplicated with the thermal management systems according to the first to third embodiments may be omitted.

As illustrated in FIG. 10, the thermal management system for fuel cell vehicles according to embodiments of the present disclosure may be configured to include an air compressor 600 in place of the turbine 500.

The air compressor 600 functions to compress air and supply the air to the fuel cell 100 and may compress air from which foreign materials are removed through an air filter 700. In this case, the air discharged from the air compressor 600 is humidified through a humidifier no and then may flow into the fuel cell 100.

The product water in the liquid state, generated from the fuel cell 100, is supplied to the heat exchange chamber 400 through the fourth valve member 440 and the ejector 450 and is accumulated in the heat exchange chamber 400 while a fifth valve member 430′ is operated in a partial shut-off mode.

The heat exchange chamber 400 is connected to the air compressor 600 through the fifth valve member 430′ so that the product water flow is possible. When the fifth valve member 430′ is operated to open the fluid channel between the heat exchange chamber 400 and the air compressor 600, the product water in the heat exchange chamber 400 is released toward the air compressor 600.

Referring to FIG. 11, the high-pressure and high-temperature refrigerant discharged from the compressor 210 of the refrigerant line 200 is subjected to heat exchange with the product water accumulated in the heat exchange chamber 400 while passing through an inner portion of the heat exchange chamber 400. In this case, the product water in the heat exchange chamber 400 absorbs the condensation heat of the refrigerant and is subjected to phase transition into steam having a high-temperature and high-pressure state.

The steam (i.e., the product water having the gas state) discharged from the heat exchange chamber 400 in the high-temperature and high-pressure state is supplied to the air compressor 600, rotates an auxiliary impeller 650 of the air compressor 600, thus reduces consumption energy of the air compressor 600, and may increase energy efficiency of the fuel cell system.

Further, because the refrigerant line 200 is operated in the cooling mode, the refrigerant passing through the heat exchange chamber 400 becomes a super-cooled state while emitting heat at the condenser 220, and accordingly cooling capacity of the HVAC system 300 is increased.

In general, the air compressor of the fuel cell system rotates an impeller adjacent to an air inflow portion using an electric motor, and is thereby configured in a structure for compressing air suctioned to the air inflow portion.

Referring to FIG. 12, the air compressor 600 of the thermal management system is configured in a structure of using a turbine shaft and is configured to be able to compress air through the high-pressure steam discharged from the heat exchange chamber 400.

To be more specific, the air compressor 600 may be configured to include a housing 610 that has an air inflow part 611 and an air discharge part 612, a steam inflow part 613 and a steam discharge part 614, a rotation shaft 620 that is rotatably disposed in the housing 610, a shaft driver 630 that is for driving the rotation shaft 620, a main impeller 640 that is provided at one axial end of the rotation shaft 620, and an auxiliary impeller 650 that is provided at the other axial end of the rotation shaft 620 and is integrally connected to the main impeller 640.

The shaft driver 630 may be configured in a structure of a rotor and stator of a general electric motor and rotates the rotation shaft 620 when an electric current is applied.

The rotation shaft 620 is driven by the shaft driver 630 and may be simultaneously driven using the product water (i.e., the steam having the high pressure state) supplied through the steam inflow part 613 as a working fluid. The steam inflow part 613 is supplied with the steam (i.e., the product water) of the high-pressure state which is discharged from the heat exchange chamber 400 through the fifth valve member 43o′.

The steam having the high-pressure state which is supplied to the inner portion of the housing 610 through the steam inflow part 613 rotates the auxiliary impeller 650 by means of pressure energy thereof, and the main impeller 640 is integrally rotated along with the auxiliary impeller 650 through the rotation shaft 620, and thereby compresses air flowing into the housing 610 through the air inflow part 611.

In this case, air compressed by the main impeller 640 is supplied to the fuel cell 100 through the air discharge part 612, and the steam having the high-pressure state is decompressed while rotating the auxiliary impeller 650 and then is discharged to the outside through the steam discharge part 614.

In this manner, the air compressor 600 rotates the main impeller 640 using the pressure energy of the steam discharged from the heat exchange chamber 400 and assists driving of the rotation shaft 620, and thereby consumption power of the shaft driver 630 is reduced.

That is, the pressure energy of the steam is used as the auxiliary power of the air compressor 600, and thereby the load of the air compressor 600 is reduced.

Here, the auxiliary impeller 650 may be called a first impeller, and the main impeller 640 may be called a second impeller.

Although the specific embodiments of the present disclosure have been described in detail hereinabove, the terms or words used in the present specification and in the appended claims should not be interpreted as being limited merely to common and dictionary meanings. In addition, the scope of the right of the present disclosure is not limited to the foregoing embodiments. Those skilled in the art could make various modifications and improvements on the basis of the principles of the present disclosure defined in the appended claims without departing from the scope of the present disclosure as defined in the appended claims.

What is claimed is:

1. A thermal management system for a fuel cell vehicle, the thermal management system comprising:
a fuel cell that generates product water as a by-product of an electrochemical reaction of fuel and air when electricity is produced by the fuel cell;
a refrigerant line through which a refrigerant for an air-conditioning system can be circulated and on which a compressor configured to compress the refrigerant is to be provided; and
a heat exchange chamber provided on the refrigerant line so as to enable heat exchange between the product water and the refrigerant.

2. The thermal management system of claim 1, wherein the heat exchange chamber is connected to the air-conditioning system through a valve member so as to enable the product water to flow.

3. The thermal management system of claim 2, wherein the heat exchange chamber is configured to accumulate the product water flowing in from the fuel cell while the valve member is being controlled in a shut-off mode.

4. The thermal management system of claim 3, wherein the product water accumulated in the heat exchange chamber is evaporated through heat exchange with the refrigerant and is supplied to the air-conditioning system through the valve member when the valve member is controlled in an open mode.

5. The thermal management system of claim 1, wherein the refrigerant line is provided with a condenser disposed downstream of the heat exchange chamber, and wherein the refrigerant evaporating the product water in the heat exchange chamber is super-cooled in the condenser.

6. The thermal management system of claim 1, wherein the fuel cell is connected to the heat exchange chamber and a vehicle outer portion through a valve member so that the product water is enabled to flow.

7. The thermal management system of claim 1, wherein the heat exchange chamber is connected to an air compressor for the fuel cell through a valve member so that the product water is enabled to flow.

8. The thermal management system of claim 7, wherein the air compressor comprises:
a first impeller configured to be rotated by the production water supplied through the valve member;
a second impeller integrally connected to the first impeller through a rotation shaft and configured to compress air supplied to the fuel cell; and
a shaft driver configured to rotate the rotation shaft when an electric current is applied.

9. A thermal management system for a fuel cell vehicle, the thermal management system comprising:
a fuel cell that generates product water as a by-product of an electrochemical reaction of fuel and air when electricity is produced by the fuel cell;
a refrigerant line through which a refrigerant for an air-conditioning system can be circulated and on which a compressor for compressing the refrigerant is to be provided;
a heat exchange chamber provided on the refrigerant line so as to enable heat exchange between the product water and the refrigerant; and
an electricity generating turbine connected to the heat exchange chamber through a valve member so that the product water is enabled to flow.

10. The thermal management system of claim 9, wherein the heat exchange chamber is configured to be accumulated with the product water flowing in from the fuel cell while the valve member is being controlled in a shut-off mode.

11. The thermal management system of claim 10, wherein the product water accumulated in the heat exchange chamber is to be evaporated through the heat exchange with the refrigerant and supplied to the turbine to rotate the turbine when the valve member is controlled in an open mode.

12. The thermal management system of claim 11, wherein the turbine is electrically connected to an in-vehicle battery so that electricity produced by the turbine can be stored in the battery.

13. The thermal management system of claim 9, further comprising an ejector configured to send the product water discharged from the fuel cell to the heat exchange chamber under a pressure, the ejector being provided between the fuel cell and the heat exchange chamber, wherein the ejector is configured to use the product water, supplied through the valve member, as a working fluid.

14. A fuel cell vehicle comprising:
a vehicle body;
a fuel cell mounted in the vehicle body;
a refrigerant line through which a refrigerant for an air-conditioning system can be circulated;
a compressor on the refrigerant line and configured to compress the refrigerant; and
a heat exchange chamber provided on the refrigerant line so as to enable heat exchange between product water and the refrigerant, the product water being a by-product of an electrochemical reaction of the fuel cell.

15. The fuel cell vehicle of claim 14, further comprising the air-conditioning system on the refrigerant line, wherein the heat exchange chamber is connected to the air-conditioning system through a valve member so as to enable the product water to flow.

16. The fuel cell vehicle of claim 15, wherein the heat exchange chamber is configured to accumulate the product water flowing in from the fuel cell while the valve member is being controlled in a shut-off mode.

17. The fuel cell vehicle of claim 16, wherein the product water accumulated in the heat exchange chamber can be evaporated through heat exchange with the refrigerant and supplied to the air-conditioning system through the valve member when the valve member is controlled in an open mode.

18. The fuel cell vehicle of claim 14, wherein the refrigerant line is provided with a condenser disposed downstream of the heat exchange chamber, and wherein the refrigerant evaporating the product water in the heat exchange chamber is super-cooled in the condenser.

19. The fuel cell vehicle of claim 14, wherein the fuel cell is connected to the heat exchange chamber and a vehicle outer portion through a valve member so that the product water is enabled to flow.

20. The fuel cell vehicle of claim 14, wherein the heat exchange chamber is connected to an air compressor for the fuel cell through a valve member so that the product water is enabled to flow, and wherein the air compressor comprises:
a first impeller configured to be rotated by the production water supplied through the valve member;
a second impeller integrally connected to the first impeller through a rotation shaft and configured to compress air supplied to the fuel cell; and
a shaft driver configured to rotate the rotation shaft when an electric current is applied.
